(19) United States
(12) Patent Application Publication
(10) Pub. No.: US 2021/0201729 A1
(43) Pub. Date: Jul. 1, 2021

(54) DRIVING METHOD AND DRIVING SYSTEM FOR DISPLAY APPARATUSES

(71) Applicant: HKC CORPORATION LIMITED, Shenzen City (CN)

(72) Inventor: BeiZhou Huang, Shenzen City (CN)

(21) Appl. No.: 16/758,851

(22) PCT Filed: Nov. 7, 2017
(86) PCT No.: PCT/CN2017/109746

§ 371 Date: Apr. 23, 2020

(30) Foreign Application Priority Data
Oct. 24, 2017 (CN) 201711001024.9

(51) Int. Cl. G09G 3/20

(52) U.S. Cl. CPC G09G 3/20; G09G 2310/0254; G09G 2310/0251; G09G 2310/0202; G09G 2320/0233; G09G 2310/0267

(57) ABSTRACT

The present disclosure provides a display device, a driving method and a driving system thereof. The driving method includes steps of: detecting whether a polarity of a scan signal inputted from current scan line is reversed; when the polarity of the scan signal inputted from current scan line is reversed, a time period of charging the current scan line is extended. By extending the time period of charging the scan line when the polarity of the scan signal on the scan line is reversed, the sub-pixels on the scan line can be charged normally for normal display. As a result, the defect of undesired bright and dark stripes or grid effect shown on a display device can be eliminated effectively.

### CROSS-REFERENCE TO RELATED APPLICATION

This application is a National Stage Application of PCT International Patent Application No. PCT/CN2017/109746 filed on Nov. 7, 2017, under 35 U.S.C. § 371, which claims priority to and the benefit of Chinese Patent Application No. 201711001024.9, filed on Oct. 24, 2017, and the disclosures of which are incorporated herein in its entirety by reference.

### BACKGROUND

### 1. Field

The present disclosure relates to a display technology field, more particularly to a display device, and a driving method and a driving system of the display device.

### 2. Description of the Related Art

In recent years, with continuous development of display technology, a development trend of display devices such as liquid crystal panel or display is towards compactness, larger screen, low power consumption and low cost, for this reason, a dual gate drive architecture is widely applied to a liquid crystal display panel. Compared with conventional drive architecture, the dual gate drive architecture has double amount of gate lines and half amount of data lines, so that the amount of source driver ICs can be reduced and a manufacturing cost of the display panel can be reduced.

However, in the dual gate drive architecture, when charging polarity of a row of sub-pixels is reversed, the sub-pixel of which charging polarity is reversed becomes darker because of insufficient charging time, and it may cause undesired bright and dark stripes or grid effect on the display device.

### SUMMARY

In order to solve above-mentioned problem that, in the dual gate drive architecture, the sub-pixel of which charging polarity is reversed becomes darker because of insufficient charging time, and it may cause undesired bright and dark stripes or grid effect on the display device, the present disclosure provides a display device, a driving method and a driving system thereof.

In an embodiment, the present disclosure provides a driving method of a display device. The display device includes a plurality of scan lines, and each of the plurality of scan lines is electrically connected to a column of sub-pixels. The method includes steps: detecting whether a polarity of a scan signal inputted from current scan line is reversed; extending a time period of charging the current scan line when the polarity of the scan signal inputted from the current scan line is reversed.

Preferably, the step of detecting whether the polarity of the scan signal inputted from the current scan line is reversed further includes: comparing whether a polarity of a scan signal inputted from last scan line is equal to the polarity of the scan signal inputted from the current scan line; determine that the polarity of the scan signal inputted from the current scan line is reversed when the polarities of the scan signal inputted from last scan line is different from the polarity of the scan signal inputted from the current scan line.

Preferably, the display device includes a gate drive module electrically connected to the plurality of scan lines, and the step of extending the time period of charging the current scan line further includes: increasing a duty cycle of an enable signal outputted to the gate drive module while the current scan line is charged, to extend the time period of charging the current scan line, wherein the enable signal corresponds to the current scan line.

Preferably, the display device includes a display panel driven by a two-line inversion manner, and the display panel is electrically connected to the plurality of scan lines, and the step of extending the time period of charging the current scan line when the polarity of the scan signal inputted from the current scan line is reversed further includes: charging the current scan line in a first predetermined time period when the current scan line is an odd-row of scan line; charging the current scan line in a second predetermined time period when the current scan line is an even-row of scan line. The first predetermined time period is longer than the second predetermined time period.

According to an embodiment, the present disclosure provides a driving system of a display device, wherein the display device comprises a plurality of scan lines, and each of the plurality of scan lines is electrically connected to a row of sub-pixels, and the driving system includes a polarity detection unit configured to detect whether a polarity of a scan signal inputted from current scan line is reversed; a time extending unit configured to extend a time period of charging the current scan line when the polarity of the scan signal inputted from the current scan line is reversed.

Preferably, the polarity detection unit further includes: a comparing unit configured to compare whether a polarity of a scan signal inputted from last scan line is equal to the polarity of the scan signal inputted from the current scan line; a determining unit configured to determine that the polarity of the scan signal inputted from the current scan line is reversed when the polarities of the scan signal inputted from last scan line is different from the polarity of the scan signal inputted from the current scan line.

Preferably, the display device includes a gate drive module electrically connected to a plurality of scan lines, and the time extending unit is configured to increase a duty cycle of an enable signal outputted to the gate drive module while the current scan line is charged, so as to extend the time period of charging the current scan line, and the enable signal corresponds to the current scan line.

Preferably, the display device includes a display panel driven by a two-line inversion manner, and the display panel is electrically connected to a plurality of scan lines, and the time extending unit further includes a first charging unit configured to charge the current scan line in a first predetermined time period when the current scan line is an odd-row of scan line; and a second charging unit configured to charge the current scan line in a second predetermined time period when the current scan line is an even-row of scan line. The first predetermined time period is longer than the second predetermined time period.

According to an embodiment, the present disclosure provides a display device. The display device includes: a display panel including a plurality of scan lines, and each of the plurality of scan lines electrically connected to a row of sub-pixels corresponding thereto; a gate drive module electrically connected to all rows of sub-pixels of the display panel through the plurality of scan lines; a control module electrically connected to the gate drive module and configured to output an enable signal; and above-mentioned driving system.

According to an embodiment, the present disclosure provides a driving method of a display device. The display device includes a plurality of scan lines and a gate drive module, and each of the plurality of scan lines is electrically connected to a row of sub-pixels corresponding thereto, and the gate drive module is electrically connected to the plurality of scan lines. The driving method includes: comparing whether a polarity of a scan signal inputted from last scan line is equal to a polarity of a scan signal inputted from current scan line; determining that the polarity of the scan signal inputted from the current scan line is reversed when the polarity of the scan signal inputted from the last scan line is different from the polarity of the scan signal inputted from the current scan line; determining that the polarity of the scan signal inputted from the current scan line is not reversed when the polarity of the scan signal inputted from the last scan line is equal to the polarity of the scan signal inputted from the current scan line; and when the polarity of the scan signal inputted from the current scan line is reversed, increasing a duty cycle of an enable signal outputted to the gate drive module while the current scan line is charged, so as to extend a time period of charging the current scan line. The enable signal corresponds to the current scan line.

According to above-mentioned content, by extending the time period of charging the scan line when the polarity of the scan signal on the scan line is reversed, the sub-pixels on the scan line can be charged normally for normal display. As a result, the defect of undesired bright and dark stripes or grid effect shown on a display device can be eliminated effectively.

### BRIEF DESCRIPTION OF THE DRAWINGS

The structure, operating principle and effects of the present disclosure will be described in detail by way of various embodiments which are illustrated in the accompanying drawings.

FIG. 1 is a schematic view of a display device based on the dual gate drive architecture, in accordance with an embodiment of the present disclosure.

FIG. 2 is a flow chart of a driving method of a display device of an embodiment of the present disclosure.

FIG. 3 is a flow chart of a step S20 of an embodiment of the present disclosure.

FIG. 4 is a schematic view of a control signal and a scan signal of an embodiment of the present disclosure.

FIG. 5 is a block diagram of a driving system of a display device, in accordance with an embodiment of the present disclosure.

FIG. 6 is a block diagram of a time extending unit of a driving system of an embodiment of the present disclosure.

FIG. 7 is a block diagram of a display device of an embodiment of the present disclosure.

### DETAILED DESCRIPTION OF THE PREFERRED EMBODIMENTS

The following embodiments of the present disclosure are herein described in detail with reference to the accompanying drawings. These drawings show specific examples of the embodiments of the present disclosure. It is to be understood that these embodiments are exemplary implementations and are not to be construed as limiting the scope of the present disclosure in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

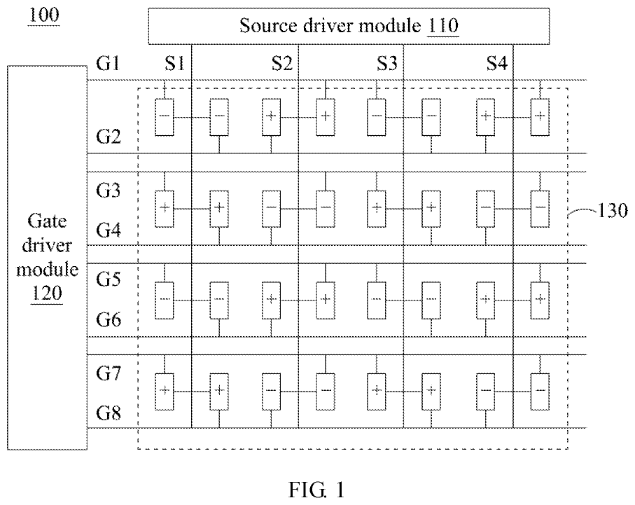

Please refer to FIG. 1 which shows a display device 100 based on a dual gate drive architecture, in accordance with an embodiment of the present disclosure. The display device 100 includes a source driver module 110, a gate driver module 120 and a display panel 130. The display panel 130 includes sub-pixels arranged in a matrix with m rows and n columns, and each row of sub-pixels is electrically connected to a scan line, wherein m and n are positive integers equal to or more than one.

In a specific application, the source driver module 110 can be any component or circuit having data driving function for the pixels of the display panel, for example, the source driver module can be a source driver IC or source-chip on film (S-COF).

In a specific application, the gate driver module can be any component or circuit having scan charging function for the pixels of the display panel, for example, the gate driver module can be a gate driver IC or a gate-chip on film (G-COF).

In a specific application, each row of sub-pixels in the pixel array includes multiple sets of sub-pixels, and each set of sub-pixels includes a first color sub-pixel, a second color sub-pixel and a third color sub-pixel arranged in a preset order. The colors of sub-pixels arranged on the same column are the same. The first color sub-pixel, the second color sub-pixel and the third color sub-pixel at least include a red sub-pixel, a green sub-pixel and a blue sub-pixel.

In an embodiment of the present disclosure, the display panel applies the dual gate drive architecture in cooperation with the two-line inversion manner, so that, in each set of three sub-pixels, polarities of two adjacent sub-pixels both are first polarity, and a polarity of the other sub-pixel is second polarity, and the first polarity and the second polarity include a positive polarity and a negative polarity. In the same row of sub-pixels, the polarity is reversed every two sub-pixels. In the same column of sub-pixels, the polarities of adjacent sub-pixels are different.

FIG. 1 shows a display panel 130 including sub-pixels arranged in a matrix with 4 rows and 8 columns, and the symbol “+” indicates the positive polarity, and the symbol “−” indicates the negative polarity.

In a specific application, compared with conventional drive architecture, the dual gate drive architecture has double amount of the gate lines and half amount of the data lines, so that the amount of the source driver IC required in the display device can be reduced, and the manufacturing cost of the display device can also be reduced.

However, the display device based on the dual gate drive architecture may have undesired bright and dark stripes or grid effect shown on display screen because the sub-pixel, of which polarity is reversed, is not charged by sufficient time period and becomes darker when the charging polarity of the row of sub-pixels of the dual gate drive architecture is reversed.

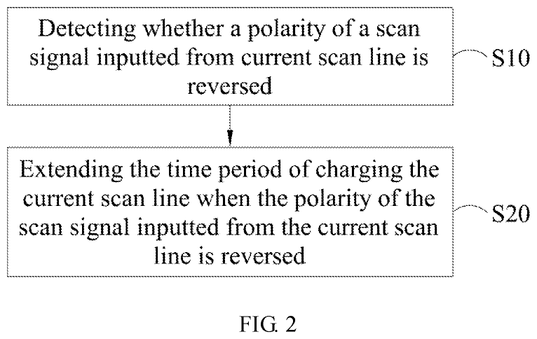

Please refer to FIG. 2. A driving method of a display device of an embodiment of the present disclosure includes following steps.

In step S10, it is detected whether a polarity of a scan signal inputted from current scan line is reversed.

In a specific application, by determining whether the polarity of the scan signal is changed, it can determine whether the polarity of the scan signal is reversed. When the polarity of the scan signal is changed, the polarity of the scan signal can be determined to be reversed.

In an embodiment, the step S10 further includes: comparing whether a polarity of a scan signal inputted from last scan line is equal to the polarity of the scan signal inputted from the current scan line; and determining the polarity of the scan signal inputted from the current scan line is reversed when the polarities of the scan signals inputted from the last scan line and the current scan line are different.

In step S20, the time period of charging the current scan line is extended when the polarity of the scan signal inputted from the current scan line is reversed.

In a specific application, the time period of charging can be regulated by adjusting a duty cycle of an enable signal outputted to the gate driver module; when the duty cycle is higher, the time period of charging is longer; otherwise, when the duty cycle is lower, the time period of charging is shorter.

In an embodiment, the step S20 can be implemented by: increasing the duty cycle of the enable signal outputted to the gate driver module while the current scan line is charged when the polarity of the scan signal inputted from the current scan line is reversed, so as to extend the time period of charging the current scan line. The enable signal corresponds to the current scan line.

In an actual application, when the charging polarity of the row of sub-pixels is reversed, the sub-pixel of which polarity is reversed becomes darker because of insufficient charging time, and it may cause the defect of undesired bright and dark stripes or grid shown on display screen. Therefore, aforementioned driving method can be applicable to any display device which repeatedly reverses charging polarities of the row of sub-pixels, and not limited to the display device based on the dual gate drive architecture.

In an embodiment of the present disclosure, by extending time period of charging the scan line of which polarity is reversed, the sub-pixels on the scan line can be charged normally for normal display, so that the defect of the undesired bright and dark stripes or grid shown on the display device can be eliminated effectively.

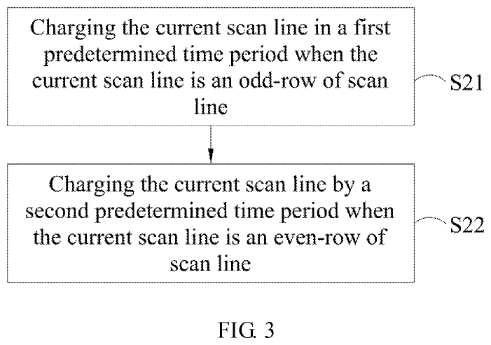

Please refer to FIG. 3. In an embodiment of the present disclosure, when aforementioned driving method is applied to a display device based on the dual gate architecture and driven by the two-line inversion manner, the step S20 can further include:

Step S21: charging the current scan line in a first predetermined time period when the current scan line is an odd-row of scan line;

Step S22: charging the current scan line in a second predetermined time period when the current scan line is an even-row of scan line.

The first predetermined time period is higher than the second predetermined time period.

In a specific application, according to analysis on the display device based on the dual gate drive architecture shown in FIG. 1, the charging polarity of the sub-pixel is reversed at the odd rows; for this reason, the time period of charging the odd row of scan line can be extended to make the time period of charging the odd-row of scan line higher than the time period of charging the even-row of scan line, thereby enabling the odd rows of sub-pixels to display with normal luminance and ensuring the display device to display normally.

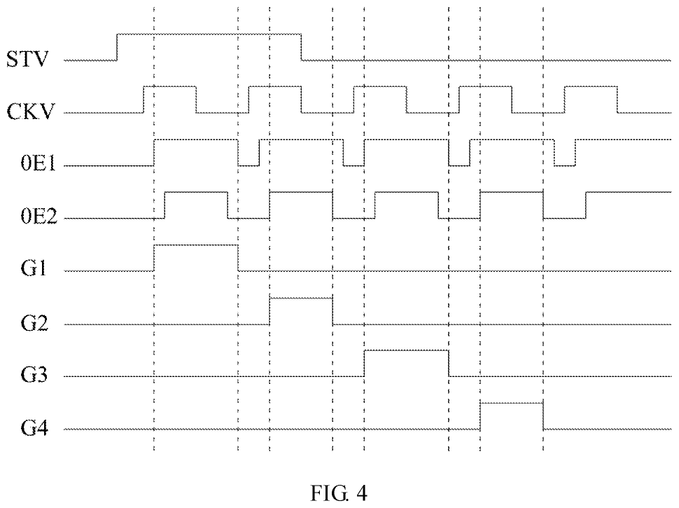

Please refer to FIG. 4, which shows a schematic view of control signals inputted to the gate driver module and scan signals outputted from the gate driver module to scan lines. As shown in FIG. 4, the symbol “STV” indicates a shift register control signal of the gate driver module, the symbol “CKV” indicates a clock signal, the symbol “OE1” indicates the enable signal for adjustment in the time period of charging of the odd-row of scan line, the symbol “OE2” indicates the enable signal for adjustment in the time period of charging the even-row of scan line, and the symbols “G1” through “G4” indicate the scan signals on four scan lines, respectively.

According to an embodiment, the present disclosure further provides a driving method of a display device, and the driving method can be implemented by above-mentioned steps in cooperation with FIGS. 2 and 3.

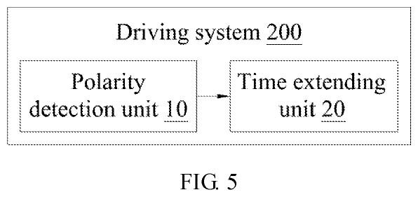

The driving method includes steps of: comparing whether polarities of the scan signal inputted from the last scan line and the current scan line are the same; determining the polarity of the scan signal inputted from the current scan line is reversed when the polarities of the scan signals inputted from the last scan line and the current scan line are different; otherwise, determining the polarity of the scan signal inputted from the current scan line is not reversed when the polarities of the scan signals inputted from the last scan line and the current scan line are the same; when the polarity of the scan signal inputted from of the current scan line is reversed, increasing the duty cycle of the enable signal outputted to the gate driver module and corresponding to the current scan line while the current scan line is charged, so as to extend the time period of charging the current scan line. Please refer to FIG. 5, which shows a driving system 200 of a display device of an embodiment of the present disclosure.

The driving system 200 can execute the steps of the driving method of FIG. 2, and includes a polarity detection unit 10 and a time extending unit 20. The polarity detection unit 10 is configured to detect whether the polarity of the scan signal inputted from the current scan line is reversed. The time extending unit 20 is configured to extend the time period of charging the current scan line when the polarity of the scan signal inputted from the current scan line is reversed.

In a specific application, the driving system 200 can be a software program system in a control module of the display device.

In a specific application, by determining whether the polarity of the scan signal is changed, it can determine whether the polarity of the scan signal is reversed. When the polarity is changed, the polarity of the scan signal is determined to be reversed.

In an embodiment, the polarity detection unit 10 may include a comparing unit configured to compare whether the polarity of the scan signal inputted from the last scan line is equal to the polarity of the scan signal inputted from the current scan line; and a determining unit configured to determine that the polarity of the scan signal inputted from the current scan line is reversed when the polarity of the scan signal inputted from the last scan line is different from the polarity of the scan signal inputted from the current scan line.

In a specific application, the time period of charging the scan line can be regulated by adjusting the duty cycle of the enable signal outputted to the gate driver module. When the duty cycle is higher, the time period of charging the scan line is longer; when the duty cycle is lower, the time period of charging the scan line is shorter.

In an embodiment, while the current scan line is charged, the time extending unit 20 can increase the duty cycle of the enable signal outputted to the gate driver module and corresponding to the current scan line, so as to extend the time period of charging the current scan line.

In an actual application, when the charging polarity of the row of sub-pixels is reversed, the sub-pixel of which polarity is reversed becomes darker because of insufficient charging time, and it may cause undesired bright and dark stripes or grid shown on the display device. Therefore, aforementioned driving system can be applicable to any display device which repeatedly reverses the charging polarity of the row of sub-pixels, and is not limited to the display device based on dual gate drive architecture.

In an embodiment of the present disclosure, the time period of charging the scan line in which the polarity is reversed can be extended to charge the sub-pixel on the scan line normally, so that the sub-pixel can display normally and the undesired bright and dark stripes or grid shown on the display device can be eliminated effectively.

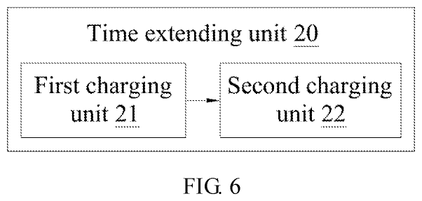

Please refer to FIG. 6. In an embodiment of the present disclosure, the driving system 200 may be applicable to the display device based on the dual gate drive architecture and driven by the two-line inversion manner, and the time extending unit 20 may include a first charging unit 21 configured to charge the current scan line in the first predetermined time period when the current scan line is the odd-row of scan line; a second charging unit 22 configured to charge the current scan line in the second predetermined time period when the current scan line is the even-row of scan line, and the first predetermined time period is longer than the second predetermined time period.

In a specific application, according to analysis on the display device based on the dual gate drive architecture shown in FIG. 1, the charging polarity of the sub-pixel is reversed at odd rows; for this reason, the time period of charging the odd rows of scan line must be extended to make the time period of charging the odd-row of scan line longer than the time period of charging the even-row of scan line. As a result, the odd row of sub-pixel can display with normal luminance, and the display device can display normally.

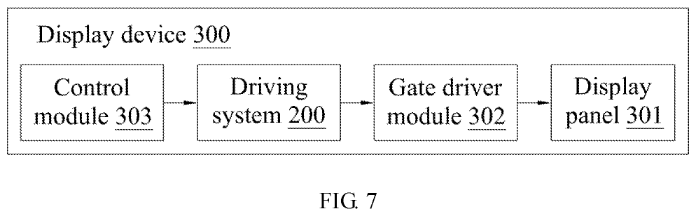

Please refer to FIG. 7, which shows a display device 300 of an embodiment of the present disclosure. The display device 300 includes a display panel 301, a gate driver module 302, a control module 303 and a driving system 200.

The display panel 301 includes a plurality of scan lines, and each of the plurality of scan lines is electrically connected to a row of sub-pixels corresponding thereto.

The gate driver module 302 is electrically connected to all rows of sub-pixels of the display panel 301 through the plurality of scan lines.

The control module 303 is electrically connected to the gate driver module 302 and configured to output the enable signal.

In an embodiment, the driving system can be the software program system in the control module and configured to execute the steps of the driving method of aforementioned embodiment.

In an embodiment, the display panel 301 can be any type of display panel, such as a liquid crystal display panel based on liquid crystal display technology, an organic electroluminescence display panel based on organic electroluminescence display technology, a Q-LED display panel based on quantum-dot light emitting diode technology, or a curved display panel.

In an embodiment, the gate driver module can be any component or circuit having scan charging function for the pixels of the display panel, for example, the gate driver module can be a gate driver IC or a gate-chip on film.

In an embodiment, the control module can be implemented by general-purpose integrated circuit such as central processing unit (CPU), or by application specific integrated circuit (ASIC). The control module may be a timing controller (TCON) of the display device.

In an embodiment, all modules or units of above-mentioned embodiment of the present disclosure can be implemented by general-purpose integrated circuit such as CPU, or by ASIC.

Those skilled in the art would realize that all flows or a part of flows of the method of aforementioned embodiments can be implemented by using computer program to control hardware, and the computer program can be stored in a computer readable storage media. The process executed by the program can include the flow of the method aforementioned embodiment. Preferably, the storage media can be a disk, an optical disk, read-only memory (ROM), or random access memory (RAM).

The present disclosure disclosed herein has been described by means of specific embodiments. However, numerous modifications, variations and enhancements can be made thereto by those skilled in the art without departing from the spirit and scope of the disclosure set forth in the claims.

1. A driving method of a display device, wherein the display device comprises a plurality of scan lines, and each of the plurality of scan lines is electrically connected to a column of sub-pixels corresponding thereto, and the method comprises:
detecting whether a polarity of a scan signal inputted from current scan line is reversed; and
extending a time period of charging the current scan line when the polarity of the scan signal inputted from the current scan line is reversed.

2. The driving method according to claim 1, wherein the step of detecting whether the polarity of the scan signal inputted from the current scan line is reversed further comprises:
comparing whether a polarity of a scan signal inputted from last scan line is equal to the polarity of the scan signal inputted from the current scan line; and
determine that the polarity of the scan signal inputted from the current scan line is reversed when the polarities of the scan signal inputted from last scan line is different from the polarity of the scan signal inputted from the current scan line.

3. The driving method according to claim 1, wherein the display device comprises a gate drive module electrically connected to the plurality of scan lines, and
the step of extending the time period of charging the current scan line further comprises:
increasing a duty cycle of an enable signal outputted to the gate drive module while the current scan line is charged, to extend the time period of charging the current scan line, wherein the enable signal corresponds to the current scan line.

4. The driving method according to claim 1, wherein the display device comprises a display panel driven by a two-line inversion manner, and the display panel is electrically connected to the plurality of scan lines;
wherein the step of extending the time period of charging the current scan line when the polarity of the scan signal inputted from the current scan line is reversed, further comprises:
charging the current scan line in a first predetermined time period when the current scan line is an odd-row of scan line; and
charging the current scan line in a second predetermined time period when the current scan line is an even-row of scan line;
wherein the first predetermined time period is longer than the second predetermined time period.

5. A driving system of a display device, wherein the display device comprises a plurality of scan lines, and each of the plurality of scan lines is electrically connected to a row of sub-pixels, and the driving system comprises:
a polarity detection unit configured to detect whether a polarity of a scan signal inputted from current scan line is reversed;
a time extending unit configured to extend a time period of charging the current scan line when the polarity of the scan signal inputted from the current scan line is reversed.

6. The driving system according to claim 5, wherein the polarity detection unit further comprises:
a comparing unit configured to compare whether a polarity of a scan signal inputted from last scan line is equal to the polarity of the scan signal inputted from the current scan line; and
a determining unit configured to determine that the polarity of the scan signal inputted from the current scan line is reversed when the polarities of the scan signal inputted from last scan line is different from the polarity of the scan signal inputted from the current scan line.

7. The driving system according to claim 5, wherein the display device comprises a gate drive module electrically connected to a plurality of scan lines;
wherein the time extending unit is configured to increase a duty cycle of an enable signal outputted to the gate drive module while the current scan line is charged, so as to extend the time period of charging the current scan line, and the enable signal corresponds to the current scan line.

8. The driving system according to claim 5, wherein the display device comprises a display panel driven by a two-line inversion manner, and the display panel is electrically connected to a plurality of scan lines;
wherein the time extending unit further comprises:
a first charging unit configured to charge the current scan line in a first predetermined time period when the current scan line is an odd-row of scan line; and
a second charging unit configured to charge the current scan line in a second predetermined time period when the current scan line is an even-row of scan line;
wherein the first predetermined time period is longer than the second predetermined time period.

9. A display device, comprising:
a display panel comprising a plurality of scan lines, wherein each of the plurality of scan lines is electrically connected to a row of sub-pixels corresponding thereto;
a gate drive module electrically connected to all rows of sub-pixels of the display panel through the plurality of scan lines;
a control module electrically connected to the gate drive module and configured to output an enable signal; and
the driving system according to claim 5.

10. A driving method of a display device, wherein the display device comprises a plurality of scan lines and a gate drive module, and each of the plurality of scan lines is electrically connected to a row of sub-pixels corresponding thereto, and the gate drive module is electrically connected to the plurality of scan lines, and the driving method comprises:
comparing whether a polarity of a scan signal inputted from last scan line is equal to a polarity of a scan signal inputted from current scan line;
determining that the polarity of the scan signal inputted from the current scan line is reversed when the polarity of the scan signal inputted from the last scan line is different from the polarity of the scan signal inputted from the current scan line;
determining that the polarity of the scan signal inputted from the current scan line is not reversed when the polarity of the scan signal inputted from the last scan line is equal to the polarity of the scan signal inputted from the current scan line; and
when the polarity of the scan signal inputted from the current scan line is reversed, increasing a duty cycle of an enable signal outputted to the gate drive module while the current scan line is charged, so as to extend a time period of charging the current scan line, wherein the enable signal corresponds to the current scan line.

11. A display device, comprising:
a display panel comprising a plurality of scan lines, wherein each of the plurality of scan lines is electrically connected to a row of sub-pixels corresponding thereto;
a gate drive module electrically connected to all rows of sub-pixels of the display panel through the plurality of scan lines;
a control module electrically connected to the gate drive module and configured to output an enable signal; and
the driving system according to claim 6.

12. A display device, comprising:
a display panel comprising a plurality of scan lines, wherein each of the plurality of scan lines is electrically connected to a row of sub-pixels corresponding thereto;
a gate drive module electrically connected to all rows of sub-pixels of the display panel through the plurality of scan lines;
a control module electrically connected to the gate drive module and configured to output an enable signal; and
the driving system according to claim 7.

13. A display device, comprising:
a display panel comprising a plurality of scan lines, wherein each of the plurality of scan lines is electrically connected to a row of sub-pixels corresponding thereto;
a gate drive module electrically connected to all rows of sub-pixels of the display panel through the plurality of scan lines;
a control module electrically connected to the gate drive module and configured to output an enable signal; and
the driving system according to claim 8.
